(19) United States
(12) Patent Application Publication
(10) Pub. No.: US 2024/0308624 A1
(43) Pub. Date: Sep. 19, 2024

(54) MOORING BUOY

(71) Applicant: Stillstrom A/S, Copenhagen (DK)

(72) Inventors: Simon WADDINGTON, Newton Wirral (GB); Xavier ERDÖDY, Aberdeen (GB); Soren MUNKESO, Kongens Lyngby (DK)

(73) Assignee: Stillstrom A/S, Copenhagen (DK)

(21) Appl. No.: 18/577,093

(22) PCT Filed: Jul. 6, 2022
(86) PCT No.: PCT/DK2022/050155

§ 371 Date: Jan. 5, 2024

(30) Foreign Application Priority Data
Jul. 9, 2021 (DK) PA202100743

(51) Int. Cl. B63B 22/02; B63B 22/04; H02G 9/12

(52) U.S. Cl. CPC B63B 22/02; B63B 22/04; H02G 9/12

(57) ABSTRACT

A mooring buoy (100) for a vessel (402) comprises a floating body (102) and at least one anchoring line (108, 110, 112) connected between the floating body and the sea floor (200). At least one mooring line (126) and electric cable (118) are arranged to be coupled between the mooring buoy and the vessel. At least one mooring buoy circuit switch (508) is electrically connected to the at least one electric cable and configured to deenergise power to the at least one electric cable. A controller (500) has a processing unit and is arranged to selectively control the at least one mooring buoy circuit switch. The controller is configured to actuate the mooring buoy circuit switch in response to a received condition signal from at least one sensor and deenergise the at least one electric cable.

### TECHNICAL FIELD

The present disclosure relates to a mooring buoy. In particular the present disclosure relates to a mooring buoy with an electric cable for connecting to a vessel.

### BACKGROUND

In the maritime industry it is often required to moor vessels when they are not in operation. In some locations, quayside space is at a premium and there is not enough space for every vessel to dock. Accordingly some vessels are moored offshore to a mooring buoy while the vessel waits to dock or before the vessel is deployed.

In most circumstances, the vessel will consume energy even when moored. This is because a moored vessel may have a residual “hotel load”. For example, the crew accommodation will require lighting and heating which consumes power. The command bridge and the instruments on the command bridge will also require power. A moored vessel may also need to carry out some deck operations with equipment that will also require power. Accordingly, a moored vessel may operate a primary or an auxiliary genset to provide power for the hotel load and other power demands.

This is undesirable because running the primary or auxiliary genset for only a hotel load will inefficiently consume fuel and emit exhaust emissions such as particulate pollution and CO₂ emissions. This may be particularly an issue if the vessel is moored close to shore within a low emissions zone.

In order to reduce emissions of moored vessels, it is known to “cold iron” vessel by providing an external power supply to the moored vessel. This means that the primary or auxiliary genset of the vessel does not need to be operational when the vessel is moored or at berth in a port.

Once such known solution is shown in US2013/0266381 which discloses a transfer system for a subsea installation which is fixed to the seabed. The transfer system comprises a transfer element such as a cable for transferring an electric current to a floating arrangement such as a vessel. The transfer system comprises a subsea fender which holds the cable when not in use. A problem with this arrangement is that the electric cable can be placed under significant tension and damaged if the vessel moves or turns with respect to the transfer system due to wind shear or sea currents.

Furthermore, the transfer system requires the vessel to be using a dynamic positioning system and vessel thrusters in order to keep the vessel in the same location of the transfer system whilst the fluid is transferred to the vessel. Maintaining a dynamic positioning system will use fuel operating the thrusters and emit exhaust emissions. This means that the transfer system is not practical for mooring the vessel for more than a few hours particularly if the location is close to shore.

Another mooring buoy for a pleasure craft is shown in US 2010/0112879. US 2010/0112879 discloses a satellite element providing connections to a water hose and an electricity cable. The water hose and electricity cable are retractable and the pleasure craft can moor alongside the buoy and a user can tie the pleasure craft to the buoy. A problem with this arrangement is that the boat cannot freely weathervane around the buoy because the water hose and other cables will twist and bend. This can damage the connections to the boat and hoses, cables etc when moored and become unsafe if the damage occurs when power is being supplied to the pleasure craft.

Examples of the present disclosure aim to address the aforementioned problems.

### SUMMARY

According to an aspect of the present disclosure there is a mooring buoy for a vessel comprising: a floating body; at least one anchoring line connected between the floating body and the sea floor; at least one mooring line arranged to be coupled between the mooring buoy and the vessel; at least one electric cable connected to an external power supply, the at least one electric cable being arranged to electrically connect to an electric circuit of the vessel; at least one mooring buoy circuit switch electrically connected to the at least one electric cable and configured to deenergise power to the at least one electric cable; a controller having a processing unit and arranged to selectively control the at least one mooring buoy circuit switch; and at least one sensor arranged to detect a condition of the mooring buoy and/or the vessel and send a condition signal to the controller; wherein the controller is configured to actuate the mooring buoy circuit switch in response to a received condition signal from the at least one sensor and deenergise the at least one electric cable.

Optionally, the mooring buoy circuit switch is a mooring buoy circuit breaker or switchgear.

Optionally, the at least one sensor is a tension sensor arranged to detect the tension in the at least one electric cable.

Optionally, the controller is arranged to actuate the mooring buoy circuit switch when the detected tension in the at least one electric cable exceeds a predetermined threshold.

Optionally, the at least one sensor is a tension sensor arranged to detect the tension in the at least one mooring line.

Optionally, the controller is arranged to actuate the mooring buoy circuit switch when the detected tension in the at least mooring line is outside a predetermined tension range.

Optionally, at least one vessel circuit breaker is electrically connected between the electric circuit of the vessel comprises and the at least one electric cable and the controller is configured to actuate the at least one vessel circuit breaker in response to the received condition signal from the at least one sensor.

Optionally, the at least at least one data connection arranged to transmit vessel parameter data between the mooring buoy and the vessel.

Optionally, the at least one data connection comprises a broadband internet connection between the mooring buoy and the vessel.

Optionally, the at least one data connection comprises an optical fibre in the at least one electric cable.

Optionally, the at least one data connection comprises a wireless data connection between the mooring buoy and the vessel.

Optionally, the controller is configured to actuate the at least one mooring buoy circuit switch in respect to a loss in connectivity in the at least one data connection between the vessel and the mooring buoy.

Optionally, the at least one sensor is one of more of a LIDAR, a camera, a voltage sensor, a frequency sensor, a moisture sensor, an accelerometer, GPS sensor, wind speed sensor, current sensor, humidity sensor, wave height sensor, smoke detection sensor.

Optionally, the external power source is an offshore power generator and at least one power generator circuit switch is electrically connected between the offshore power generator and the at least one mooring buoy circuit switch.

In another aspect of the disclosure, there is provided a mooring buoy for a vessel comprising: a floating body; at least one anchoring line connected between the floating body and the sea floor; at least one mooring line arranged to be coupled between the mooring buoy and the vessel; at least one electric cable connected to an external power supply, the at least one electric cable being arranged to electrically connect to an electric circuit of the vessel; at least one data connection being arranged to connect to a local network of the vessel; at least one mooring buoy circuit switch electrically connected to the at least one electric cable and configured to modify the energisation of at least one electric cable; a controller having a processing unit and arranged to receive vessel parameter data from the vessel over the at least one data connection; wherein the controller is arranged to selectively control the at least one mooring buoy circuit switch in response to the received vessel parameter data.

Optionally, the vessel parameter data comprises a unique vessel ID.

Optionally, the controller is configured to modify the power supplied to the at least one mooring buoy in dependence on stored vessel information and the unique vessel ID.

Optionally, the controller is configured to receive energy consumption data of the vessel and/or data consumption data of the vessel over the at least one data connection.

Optionally, the controller comprises a memory and is configured to storing energy consumption of the vessel and/or data consumption of the vessel with the unique vessel ID in the memory.

Optionally, the at least at least one data connection comprises a broadband internet connection between the mooring buoy and the local network of the vessel.

Optionally, the at least one data connection comprises an optical fibre in the at least one electric cable.

### BRIEF DESCRIPTION OF THE DRAWINGS

Various other aspects and further examples are also described in the following detailed description and in the attached claims with reference to the accompanying drawings, in which:

FIG. 1 shows a side view of a mooring buoy according to an example;

FIGS. 2 and 3 show cross-sectional side views of a mooring buoy according to an example;

FIG. 4 shows a perspective view of the mooring buoy and vessel according to an example;

FIG. 5 shows a schematic view of the mooring buoy and the different systems in the mooring buoy according to an example;

FIG. 6 shows a system diagram of the mooring buoy connected to a power generator according to an example;

FIG. 7 shows a schematic circuit diagram of the mooring buoy according to an example; and

FIG. 8 shows another schematic view of the mooring buoy.

### DETAILED DESCRIPTION

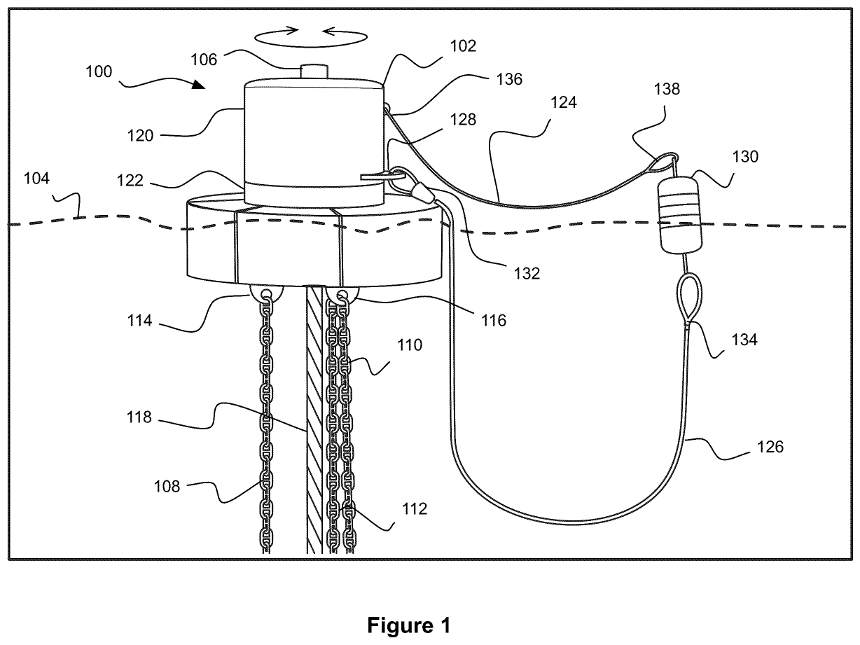

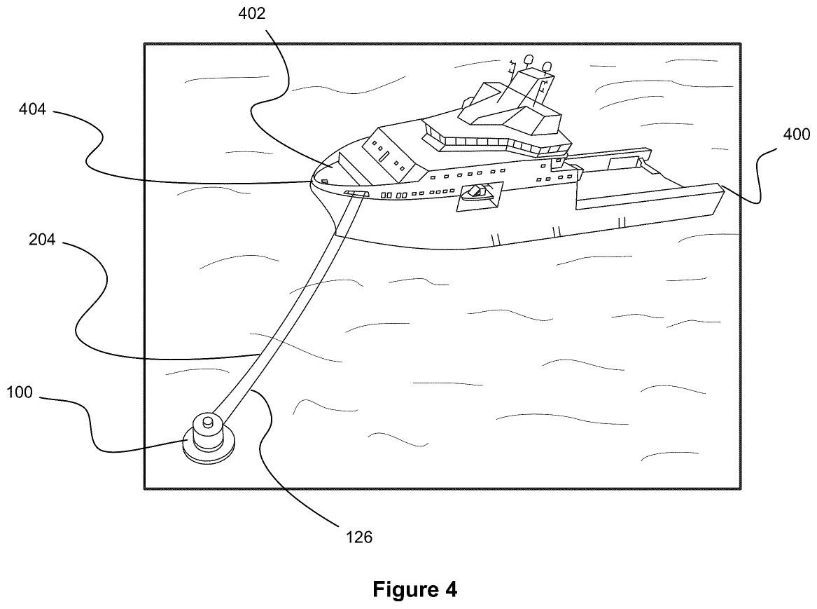

FIG. 1 shows a side view of a mooring buoy 100 for mooring a vessel 400. FIG. 1 does not show a vessel 400 to be moored but the vessel 400 is best shown in e.g. FIG. 4. FIG. 4 shows a perspective view of the vessel 400 connected to the mooring buoy 100.

The vessel 400 can be an anchor handling vessel, platform supply vessel (PSV), multipurpose support vessel (MSV), tugboat, ice breaker, patrol boat, fishing vessel, coast guard vessel, navy vessel, fire-fighting vessel, container ship, bulk carrier, barge, tanker, or any other vessel which can be moored.

Turning back to FIG. 1, the mooring buoy 100 will be discussed in more detail. The mooring buoy 100 comprises a floating body 102 and at least a portion of the floating body 102 projects out of the surface 104 of the water. The portion of the floating body 102 that projects out of the water can be brightly coloured for contrasting with the water. In some examples, one or more beacons 106 can be mounted on the floating body 102 for alerting vessels of the presence of the mooring buoy 100.

The beacon 106 in some examples is an electric light or an LED. In some examples, the beacon 106 is configured to change colour to indicate a status of the mooring buoy 100. Additionally or alternatively the beacon 106 is configured to flash and/or vary the periodicity of the flashing to indicate a status of the mooring buoy 100. In some examples the beacon 106 comprises a foghorn (not shown) for warning nearby vessel 400. In some examples the beacon 106 can be connected to an emergency light system 702 which indicates that there is a fault or emergency with the mooring buoy 100.

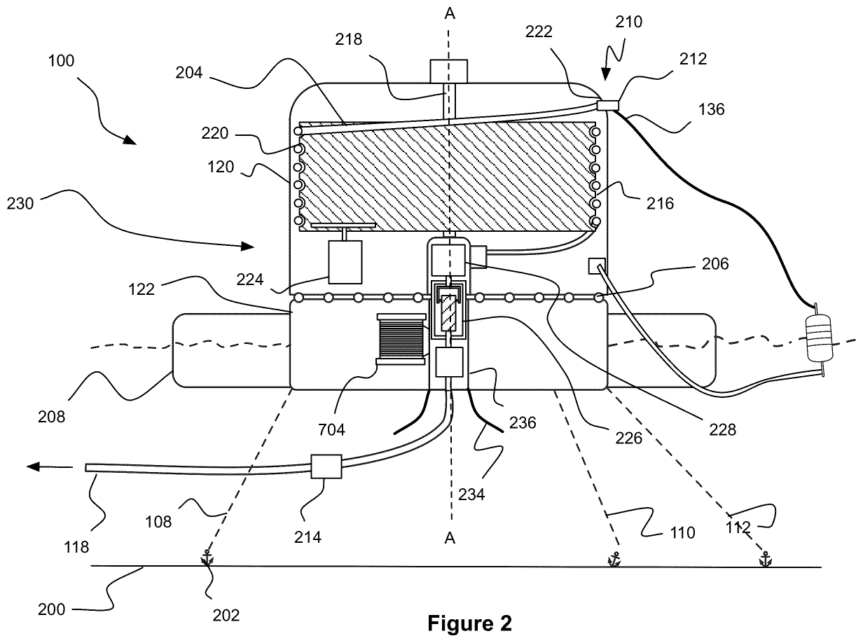

The anchoring of the mooring buoy 100 will be discussed in reference to FIGS. 1 and 2. FIG. 2 shows a cross-sectional side view of the mooring buoy 100. In some examples, the mooring buoy 100 is anchored to the sea floor 200 (e.g. as shown in FIG. 2) with a plurality buoy anchoring lines 108, 110, 112 connected between the floating body 102 and the sea floor 200. The buoy anchoring lines 108, 110, 112 are not to scale and schematically shown in FIG. 2 with respect to the sea floor 200, the surface 104 of the water and the mooring buoy 100.

The buoy anchoring lines 108, 110, 112 are connected to the floating body 102 at one or more mooring eyes 114, 116 fixed to the floating body 102. In some examples, the buoy anchoring lines 108, 110, 112 are optionally connected to the one or more mooring eyes 114, 116 via a shackle or a swivel mechanism (not shown) for allowing relative rotation between the buoy anchoring lines 108, 110, 112 and the one or more mooring eyes 114, 116. In some examples, as shown in FIG. 1 the mooring eyes 114, 116 do not comprise a shackle or a swivel mechanism.

In some examples, the buoy anchoring lines 108, 110, 112 are connected to mooring eyes (not shown) of a sinker 202 (schematically shown in FIG. 2). The sinker 202 is fixed with respect to the sea floor 200. In some examples, the buoy anchoring lines 108, 110, 112 are connected to the mooring eyes of the sinker 202 via a shackle or a swivel mechanism (not shown) for allowing relative rotation between the buoy anchoring lines 108, 110, 112 and the one or more mooring eyes of the sinker 202. The sinker 202 is embedded in the sea floor 200 or resting on the sea floor 200 and prevents the mooring buoy 100 from moving away from a predefined mooring location.

In some other examples, the sinker 202 can be replaced with an anchor (not shown) or any other suitable means for fixing the buoy anchoring lines 108, 110, 112 with respect to the sea floor 200. The sinker 202 can be made from concrete, cast iron, rock, bundles or used chain or any other suitable material.

The buoy anchoring lines 108, 110, 112 in some examples are chains (as shown in FIG. 1) or alternatively mooring ropes or wires. In other examples, the buoy anchoring lines 108, 110, 112 can be a combination of a chain, rope and/or wire. In some examples, the three buoy anchoring lines 108, 110, 112 comprise an UHMwPE (Ultra High Molecular Weight Polyethylene) or HMPE (High Modulus Polyethylene) fibre such as “DYNEEMA®”. In some examples and as shown in FIG. 1, the mooring buoy 100 comprises a three-point mooring system using three buoy anchoring lines 108, 110, 112. Each of the buoy anchoring lines 108, 110, 112 is connected to a stationary portion 122 of the floating body 102 spaced apart circumferentially approximately at 120 degrees about the floating body 102 and respectively attached to separate sinkers 202. In a less preferred example, the mooring buoy 100 comprises a single-point mooring system using a single mooring buoy anchoring lines 108.

The buoy anchoring lines 108, 110, 112 in some examples provide a slack mooring. In this way, when the loading on the mooring buoy 100 is at a maximum, the mooring buoy anchoring lines 108, 110, 112 catenary will meet the sea floor 200 some way from the sinker 202. By providing the buoy anchoring lines 108, 110, 112 with a chain on the sea floor 200, this increases the security of the mooring or may be used to reduce the size of the sinker 202. The slack mooring also allows the mooring buoy 100 to move up and down due to the heave motion of the water. Alternatively, the buoy anchoring lines 108, 110, 112 in some other examples provide a taught mooring and the buoy anchoring lines 108, 110, 112 are mooring ropes under tension between the floating body 102 and the sea floor 200.

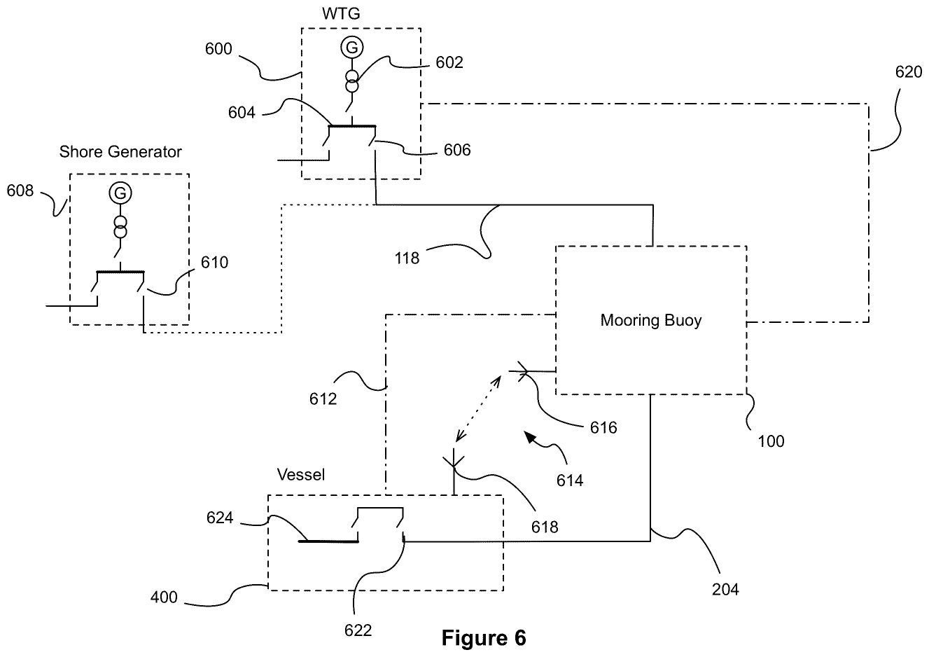

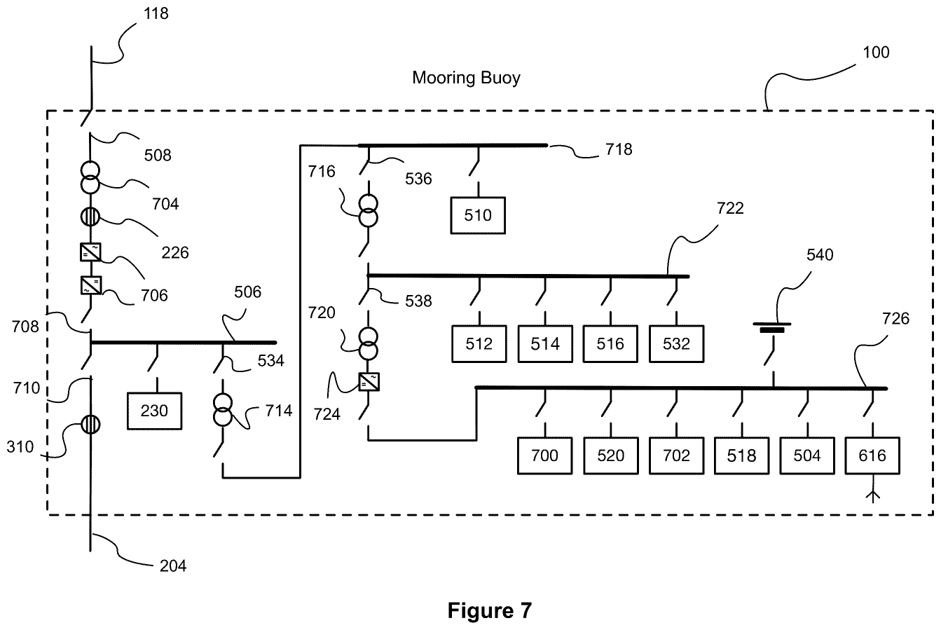

An input subsea electric cable 118 is connected to the mooring buoy 100. The input subsea electric cable 118 is electrically connected to an external power supply. The electrical connections to the mooring buoy 100 will be discussed in further detail with respect to FIGS. 6 and 7 below.

Turning back to FIG. 1, the mooring buoy 100 will be discussed in further detail. The floating body 102 optionally comprises a rotatable portion 120 and a stationary portion 122. The buoy anchoring lines 108, 110, 112 are fixed to the stationary portion 122 of the floating body 102. This means that the stationary portion 122 is substantially fixed with respect to the sea floor 200. The rotatable portion 120 is arranged to rotate about axis A-A (as best shown in FIG. 2) and as indicated by the double ended arrow in FIG. 1. Rotation of the rotatable portion 120 with respect to the stationary portion 122 will be discussed in more detail below. Whilst the examples as shown in the Figures show the mooring buoy 100 with a rotatable portion 120 and a stationary portion 122, the floating body 102 may be fixed and does not rotate with respect to other parts of the mooring buoy 100.

The mooring buoy 100 comprises an output electric cable 204 (best shown in FIG. 2) for providing external power to the vessel 400. The output electric cable 204 is optionally connected to a messenger line 124 at a first end 136 of the messenger line 124. A second end 138 of the messenger line 124 is connected to the messenger line buoy 130. Use of the messenger line 124 for connecting and mooring the vessel 400 to the mooring buoy 100 will be described in more detail below.

A mooring line 126 is connected to the floating body 102 at a first end 132 of the mooring line 126. A second end 134 of the mooring line 126 is arranged to be connected to a capstan (not shown) or another suitable mooring point on the vessel 400. In this way the mooring line 126 is arranged to tether the vessel 400 to the mooring buoy 100.

As shown in FIG. 1, the second end 134 of the mooring line 126 is also connected to the messenger line buoy 130. The mooring line 126 is draped into the water and sinks to form a “U-shape”. The messenger line buoy 130 allows the second end 134 of the mooring line 126 to be identified and picked up by the vessel 400. Although not shown, the mooring line 126 can be retractable into the mooring buoy 100. In some examples, the mooring buoy 100 comprises a mooring line winding mechanism (not shown) such as a winch for retracting and extending the mooring line 126 with respect to the mooring buoy 100.

However, a preferred arrangement is that the second end 134 of mooring line 126 is remote from the mooring buoy 100. The prevailing current of the water and/or the wind will move the messenger line buoy 130 in the direction of the current until the messenger line 124 and/or the mooring line 126 are fulling extended in the water. This means that the vessel 400 does not have to approach too close to the mooring buoy 100 during a mooring operation.

As shown in FIG. 1, the mooring line 126 is connected to the rotatable portion 120 via a mooring eye 128. This means that the mooring line 126 is configured to rotate about the stationary portion 122 with the rotatable portion 120. In some other examples, optionally, the mooring line 126 is rotatably or slidably connected to the stationary portion 122.

The mooring buoy 100 comprises at least one mooring line 126 connectable between the mooring buoy 100 and the vessel 400. In some examples, the mooring line 126 is a chain or alternatively mooring ropes or wires. In other examples, the mooring line 126 can be a combination of a chain, rope and/or wire. In some examples, the mooring line 126 comprises an UHMwPE (Ultra High Molecular Weight Polyethylene) or HMPE (High Modulus Polyethylene) fibre such as “DYNEEMA®” (a trade mark of Royal DSM N.V.) Alternatively, the mooring line 126 can be made from a material less dense than water such that it floats. For example, the mooring line 126 comprise an UHMwPE (Ultra High Molecular Weight Polyethylene) or HMPE (High Modulus Polyethylene) fibre with a density less than the density of fresh water or salt water.

In some other less preferred examples, the messenger line 124 and the messenger line buoy 130 are optional. In this less preferred example the vessel 400 approaches the mooring buoy 100 and picks up the output electric cable 204 and the mooring line 126 without the aid of the messenger line 124.

Turning to FIG. 2, the mooring buoy 100 will be discussed in further detail. FIG. 2 shows a cross-section side view of the mooring buoy 100 according to an example. The floating body 102 of the mooring buoy 100 is substantially cylindrical. In other examples, the floating body 102 can be box shaped, conical, hemispherical or any other suitable shape.

The floating body 102 optionally comprises an annular or peripheral fender 208 which surrounds the outer surface of the stationary portion 122. The floating body 102 of the mooring buoy 100 as shown in FIGS. 1 to 3 is substantially cylindrical and the fender 208 is annular.

The annular fender 208 is arranged to prevent the vessel 400 from damaging the floating body 102 if the vessel 400 collides with the mooring buoy 100. In some examples, the annular fender 208 is made from rubber or another resiliently deformable material arranged to absorb the impact of the vessel 400. The annular fender 208 is mounted to the stationary portion 122 however, in other examples the annular fender 208 can be mounted on the rotatable portion 120. A plurality of annular fenders 208 can be provided on the mooring buoy 100 at different heights from the surface 104 of the water.

Optionally, the mooring buoy 100 does not comprise the annular fender 208. Instead the mooring buoy 100 can be constructed from sufficiently durable materials to resist damage from vessel collision.

The rotatable portion 120 is rotatably mounted on the stationary portion 122 on a bearing 206 such as a thrust bearing. The bearing 206 is configured to support the weight of the rotatable portion 120. The bearing 206 is schematically shown in FIG. 2.

This means that the rotatable portion 120 freely rotates with respect to the stationary portion 122 about the axis A-A. The axis of rotation A-A of the rotatable portion 120 is the central axis A-A of the mooring buoy 100. However, in other examples the axis of rotation A-A is off-centre from the central axis of the mooring buoy 100.

As mentioned above, the mooring buoy 100 is connected to an external power source via an input subsea electric cable 118. The external power source connected to the mooring buoy 100 is discussed in more detail in reference to FIG. 6 below.

As shown in FIG. 2, optionally there are one or more subsea buoyancy elements 214 mounted to the input subsea electric cable 118. The one or more subsea buoyancy elements 214 are configured to create an S-profile of the input subsea electric cable 118 between the mooring buoy 100 and the sea floor 200. FIG. 2 only shows a portion of the input subsea electric cable 118 close to the mooring buoy 100 and the “S-profile” of the input subsea electric cable 118 is not shown for the purposes of clarity.

The stationary portion 122 of the mooring buoy 100 optionally comprises a funnel 234 for receiving the input subsea electric cable 118 on the underside of the mooring buoy 100. In some examples, the funnel 234 is mounted around the periphery of a moonpool 236 for receiving the input subsea electric cable 118 within the mooring buoy 100. The funnel 234 is curved and flared towards the outer edge of the stationary portion 122. The curved surface of the funnel 234 is arranged to receive a portion of the input subsea electric cable 118. The curved surface is profiled to define a maximum bend radius of the input subsea electric cable 118.

The mooring buoy 100 optionally comprises a cable length adjustment mechanism 230 configured to adjust the length of the output electrical cable 204. The cable length adjustment mechanism 230 is configured to adjust the length of the output electrical cable 204 when the rotatable portion 120 rotates with respect to the stationary portion 122. This means when the output electrical cable 204 is connected to the vessel 400, adjustment of the length of the output electrical cable 204 can manage the tension in the output electrical cable 204.

Accordingly, the cable length adjustment mechanism 230 is configured to adjust the length of the output electrical cable 204 when the moored vessel 400 moves away or toward the mooring buoy 100 due to environmental forces (such as the tide, current or wind). For example, the tension in the output electrical cable 204 can be maintained lower than the tension in the hawser or mooring line 126 even if the vessel 400 moves around the mooring buoy 100. This means that the tension in the output electrical cable 204 can be adjusted in dependence of environmental conditions, and the position and orientation of the vessel 400 with respect to the mooring buoy 100.

The output electrical cable 204 as shown in FIG. 2 is in a retracted position and the free end 210 of the output electrical cable 204 is moveable between the retracted position and an extended position. In the extended position, the output electrical cable 204 is connectable to the vessel 400.

However, in other less preferred examples, the mooring buoy 100 does not comprise a cable length adjustment mechanism 230. In this case, the output electrical cable 204 is at a fixed length. In this case, the output electrical cable 204 may be mechanically disconnected from either the mooring buoy 100 or the vessel 400 when the output electrical cable 204 exceeds a threshold tension.

The free end 210 of the output electrical cable 204 comprises a connector 212 for connection with a reciprocal connector (not shown) on the vessel 400. In some examples the connector 212 is a plug according to the standard ISO/IEC/IEEE 80005-3(−1*). In some examples, the free end 210 of the output electrical cable 204 comprises a plug or socket for connecting respectively with a socket or plug connected to an electric circuit of the vessel 400. The connector 212 and the output electrical cable 204 project out of the rotatable portion 120 through an exit hole 222. In FIG. 2, the output electrical cable 204 is fully retracted into the rotatable portion 120 and the connector 212 abuts the exit hole 222.

In some examples, the connector 212 comprises a rubber seal (not shown) for engaging the exit hole 222 when the connector 212 abuts the exit hole 222. This means that the exit hole 222 is sealed and reduces the amount of water that can enter the rotatable portion 120.

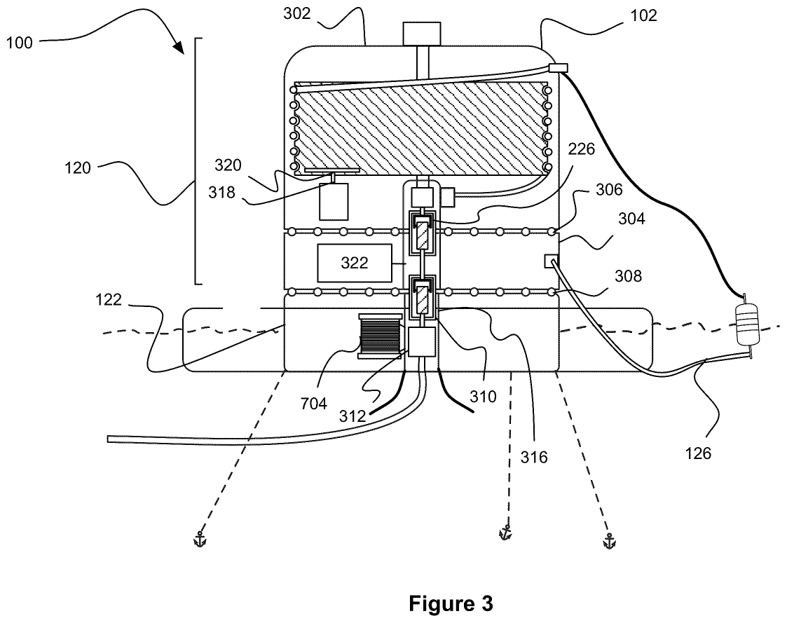

The output electrical cable 204 is electrically connected to the input subsea electric cable 118. A first rotatable electrical connection 226 is mounted between the stationary portion 122 and the rotatable portion 120 as shown in FIGS. 2 and 3. FIG. 3 shows a cross-sectional side view of a mooring buoy 100 according to an example. The mooring buoy 100 as shown in FIG. 3 is the same as discussed with respect to FIGS. 1 and 2, except that the mooring line 126 is connected to a different part of the floating body 102.

In some examples the first rotatable electrical connection 226 is an electrical slip ring. The electrical slip ring can be housed in an electrical slip ring canister 316 as shown in FIG. 3. The electrical slip ring canister 316 can seal the electrical connections of the electrical slip ring from the marine environment. The electrical slip ring 226 permits 360° rotation of the rotatable portion 120 with respect to the stationary portion 122 whilst maintaining an electrical connection between the output electrical cable 204 and the input subsea electric cable 118.

The first rotatable electrical connection 226 is optionally connected to a rotating junction box 228. The rotating junction box 228 is mounted in the rotatable portion 120. The rotating junction box 228 is a sealed enclosure for housing connections between an output from the first rotatable electrical connection 226 and the output electrical cable 204. In some examples, the connections between the output from the first rotatable electrical connection 226 and the output electrical cable 204 are pigtail connections.

Another example will now be described in more detail in reference to FIG. 3.

The rotatable portion 120 comprises a mooring line body portion 304 coupled to the mooring line 126 and an electric cable body portion 302 coupled to the output electrical cable 204. The rotatable portion 120 is rotatable with respect to the stationary portion 122. At the same time, the mooring line body portion 304 is rotatable with respect to the electric cable body portion 302.

The electric cable body portion 302 is rotatably mounted on the mooring line body portion 304 on a first bearing 306 such as a thrust bearing. The first bearing 306 is configured to support the weight of the electric cable body portion 302. The mooring line body portion 304 is rotatably mounted on the stationary portion 122 on a second bearing 308 such as a thrust bearing. The second bearing 308 is configured to support the weight of the electric cable body portion 302 and the mooring line body portion 304. In this way, the second bearing 308 is similar to the bearing 206 as discussed in reference to the examples shown in FIG. 2. The electric cable body portion 302 houses one or more electric components 322 of the mooring buoy 100. For example, one or more of the mooring buoy 100 electric components 322 as shown with respect to FIG. 7 can be mounted in the electric cable body portion 302. For the purposes of clarity, the electric components 322 of the mooring buoy 100 as shown in FIG. 7 has been collectively illustrated as a single unit. Alternatively, one or more of the electric components 322 of the mooring buoy 100 as shown in FIG. 7 can be mounted in the stationary portion 122.

This means that the output electrical cable 204 and the mooring line 126 can rotate with respect to each other in addition to rotating with respect to the stationary portion 122. Accordingly, both the output electrical cable 204 and the mooring line 126 can be aligned in the same vertical plane. This means that there is limited or no angular deviation between the output electrical cable 204 and the mooring line 126 extending from the vessel 400 to the mooring buoy 100. The forces exerts on the output electrical cable 204 and the mooring line 126 in a circumferential direction about the mooring buoy 100 are the same. This means that the output electrical cable 204 is less likely to bend sideways as the vessel 400 weathervanes about the mooring buoy 100.

Optionally an additional motor is provided to effect rotational movement between the mooring line body portion 304 and the electric cable body portion 302. In other examples, there is no motor and the rotational movement between the mooring line body portion 304 and the electric cable body portion 302 is caused by the vessel 400 moving with respect to the mooring buoy 100.

As shown in FIG. 3, a second rotatable electrical connection 310 is provided. The second rotatable electrical connection 310 is the same as the first rotatable electrical connection 226 discussed in reference to the examples shown in FIGS. 2 and 3 e.g. a second electrical slip ring 310.

The rotating electric cable body portion 302 mounted to the first bearing 306 means that the electric cable body portion 302 is able to follow the mooring line body portion 304 and the second bearing 308. This means the electric cable body portion 302 can follow the vessel movement as a slave function.

This slave functionality of the electric cable body portion 302 will ensure that the mooring line 126 and the output electric cable 204 extending from the mooring buoy 100 to the vessel 400 are always inline and at the same length avoiding vessel-cable strain issues.

The output electric cable 204 will therefore avoid any kind of overstrain from movement of the vessel 400, while continuously transferring electrical energy and telemetric signals.

As can be seen from FIG. 4, the mooring line 126 and the output electric cable 204 are connected between the mooring buoy 100 and the vessel 400. In some examples, connector 212 of the output electrical cable 204 is connected with a socket or plug in a deck junction box (not shown) in the deck 402 of the vessel 400, at the bow 404 of the vessel 400. The deck junction box is optionally mounted on the deck 402 of the vessel 400 and is connected to an electrical circuit of the vessel 400. For example the deck junction box is connected to the switchboard 624 (as best shown in FIG. 6) of the vessel 400. In this way, when the connector 212 of the output electrical cable 204 is connected to the deck junction box, the output electrical cable 204 is electrically connected to the switchboard 624 of the vessel 400 In some examples, the socket or plug in the deck 402 of the vessel 400 is retrofittable and an auxiliary cable (not shown) extends from the bow 404, side or stern of the vessel 400 to the switchboard 624 of the vessel 400.

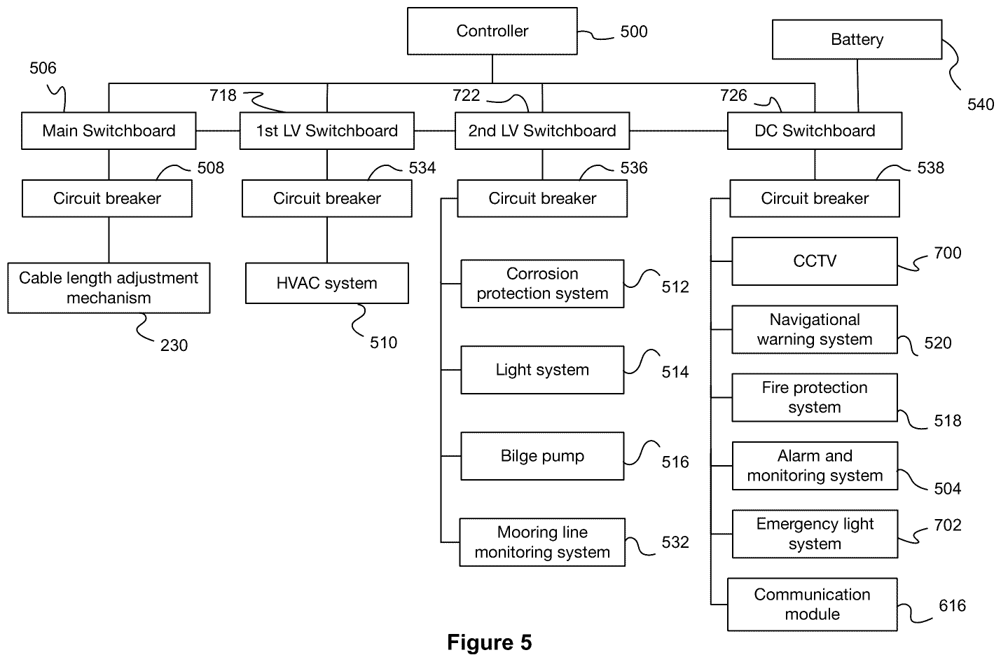

The mooring buoy 100 will be discussed in more detail with reference to FIG. 5. FIG. 5 shows a schematic view of the mooring buoy 100 and the different systems in the mooring buoy 100. The mooring buoy 100 comprises a controller 500 configured to control different systems in the mooring buoy 100.

The controller 500 is connected to at least one sensor 806 arranged to detect a condition e.g. a fault condition of the mooring buoy 100 and/or the vessel 400. The controller 500 is arranged to receive a condition signal from the at least one sensor 806. In some examples, the controller 500 is configured to open a mooring buoy circuit switch 508 electrically connected to the output electric cable 204. The controller 500 is configured to open the mooring buoy circuit switch 508 in response to a received condition signal from the at least one sensor 806 and deenergise the output electric cable 204. As shown in FIG. 5, the mooring buoy circuit switch 508 in some examples is a first mooring buoy circuit breaker 508. This means that the controller 500 is able to safely deenergise the output electric cable 204 in certain scenarios e.g. an emergency shutdown procedure.

FIG. 5 shows an exemplary arrangement of the switchgear with the controller 500 connected to a plurality of different switchboards e.g. a main mooring buoy switchboard 506, the first low voltage switchboard 718, the second low voltage switchboard 722, and the DC switchboard 726. However in other examples there may be a single main mooring buoy switchboard 506. Indeed, there may be any number of switchboards, circuit breakers and switchgear as required. The electrical circuit diagram of the mooring buoy 100 will be discussed in further detail below in reference to FIG. 7.

As shown in FIG. 5, each of the subsystems connected to one of the mooring buoy main switchboard 506, the first low voltage switchboard 718, the second low voltage switchboard 722, or the DC switchboard 726 is connected via switchgear e.g. circuit breakers 508, 534, 536, 538. In some examples, the controller 500 is configured to selectively control the switchgear. Accordingly, the controller 500 can selectively isolate one or more internal subsystems or switchboards of the mooring buoy 100.

The controller 500 is optionally mounted in the floating body 102. In some examples, the controller 500 is optionally mounted in the rotatable portion 120 adjacent to the cable length adjustment mechanism 230. For example in reference to FIG. 3, the controller 500 is mounted on the mooring line body portion 304 as illustrated by the electric components 322. The controller 500 is configured to issue control signals to the electric motor 224 for rotating the rotatable drum 216 and retracting or extending the output electric cable 204.

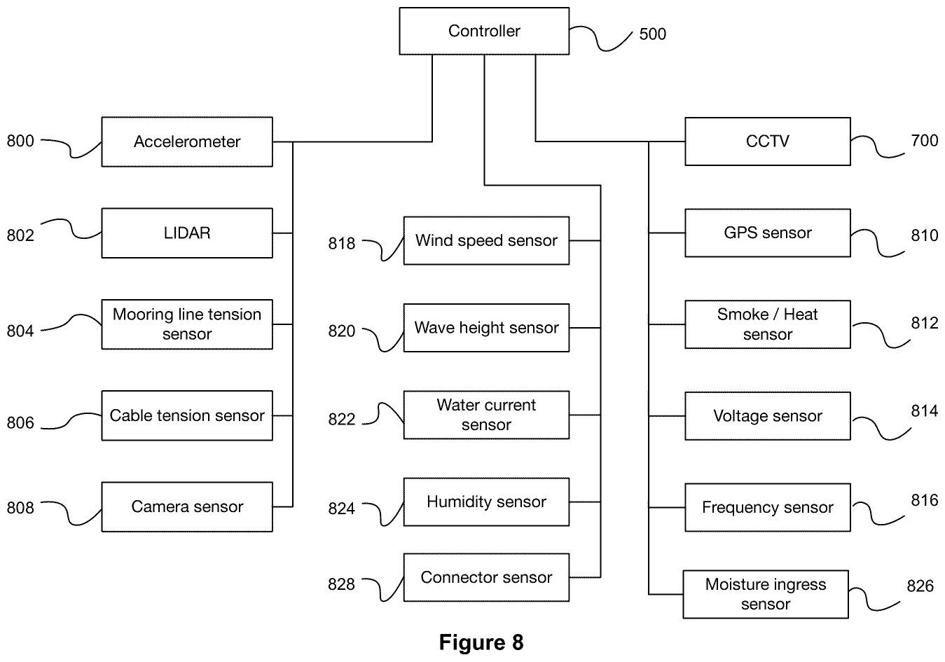

In some examples, the controller 500 is connected to the cable length adjustment mechanism 230 and the controller 500 is configured to issue a control signal to the electric motor 224 to extend or retract the output electric cable 204 in dependence of a detected tension in the output electric cable 204. In some examples, the at least one sensor 806 is a cable tension sensor 806. In this way, the tension in the output electric cable 204 is determined by the controller 500 in response to a signal from a cable tension sensor 806 (best shown in FIG. 8). The cable tension sensor 806 in some examples is a separate sensor from the electric motor 224, for example the output electric cable 204 is connected to a force sensor. In some examples the cable tension sensor 806 comprises a force sensor (not shown) coupled to a pulley (not shown) and the output electric cable 204 the passes over the pulley (not shown).

Additionally or alternatively, the cable tension sensor 806 is the operational torque, voltage and/or current feedback from the electric motor 224 itself. In some examples, the controller 500 comprises a converter unit motor drive and control system. In some other examples, the controller 500 is connected to a separate a converter unit motor drive and control system. In yet some other examples, the controller 500 is a converter unit motor drive and control system. The converter unit motor drive and control system is connected to an encoder (not shown) mounted on a drive shaft 318 of the electric motor 224. The encoder is configured to send signals to the converter unit motor drive and control system when the drive shaft 318 rotates. The controller 500 determines the cable tension of the output electric cable 204 from the signals received from the encoder mounted on the drive shaft 318 of electric motor 224 and stored parameter information of the drive pinion 320 e.g. a converter drive unit and the rotatable drum 216.

The controller 500 receives the signal from the cable tension sensor 806 and determines whether the tension of the output electric cable 204 is within a predetermined tension range. In some examples, the tension range of the output electric cable 204 is between 0N and 5 kN or 0N and 10 kN, or 0N and 15 kN, or 0N and 20 kN. In some other examples, the tension range of the output electric cable 204 is between 100 kN-10000 kN.

In some examples, the controller 500 determines whether the output electric cable tension T_{c} deviates from a predetermined optimal output electric cable tension T_{oc}. In some examples, the optimal output electric cable tension T_{oc} is 100N, 200N, 500N, 1000N, 1500N, or 2000N. The optimal output electric cable tension Tₓ may be determined from the type and length of the output electric cable 204. In some examples, the controller 1100 determines that the stress value S of the output electric cable 204 remains below 0.07 kN/mm².

In some examples the controller 500 determines that the output electric cable tension T_{c} deviates from a predetermined optimal output electric cable tension T_{oc}. In this case the controller 500 may send a control signal to an alarm and monitoring system 504. The alarm and monitoring system 504 issues a warning alert in the form of a siren. In addition, the alarm and monitoring system 504 may issue a warning alert via a wired or a wireless data connections 612, 614 (best shown in FIG. 6) to the vessel 400 or other remote entities. In some examples, the alarm and monitoring system 504 controls the beacon 106 to issue either an audible or visual alarm.

If the output electric cable tension T_{c} increases or continues to deviate from the predetermined optimal output electric cable tension T_{oc}, the controller 500 alternatively or additionally, issues a control signal to the mooring buoy main switchboard 506 to control the energisation of the output electric cable 204. In some examples, the mooring buoy main switchboard 506 trips the first mooring buoy circuit breaker 508 in dependence of a received control signal from the controller 500. Accordingly, if the controller 500 determines that the output electric cable tension T_{c} is above an optimal output electric cable tension T_{oc}, the output electric cable 204 can be deenergised before a catastrophic failure of the output electric cable 204.

If the controller 500 determines that there is a fault in one or more of the other systems of the mooring buoy 100 or a scenario deviating from normal operation of the mooring buoy 100, the controller 500 may send a control signal to an alarm and monitoring system 504. If the fault persists, then the controller 500 issues a control signal to the mooring buoy main switchboard 506 to control the energisation of the output electric cable 204.

The control signals issued by the controller 500 in response to various other exemplary scenarios will now be discussed.

Depending on the fault, the controller 500 may issue a control signal to different switchgear. For example, if the controller determines that there is an electrical fault with the input subsea electric cable 118 or e.g. a WTG 600 (best shown in FIG. 6), the controller 500 may issue a control signal to trip the first mooring buoy circuit breaker 508 to electrically isolate the mooring buoy 100 from the WTG 600. Alternatively, the if the controller 500 determines that there is an electrical fault with the vessel 400 and/or the output electrical cable 204, the controller 500 may issue a control signal to trip a second mooring buoy circuit breaker 708 or an output electric cable switchgear 710 (best shown in FIG. 7). This will electrically isolate the mooring buoy 100 from the output electrical cable 204 and the vessel 400. Furthermore, if the controller 500 detects a fault with an internal subsystem of the mooring buoy 100, the controller may issue a control signal to electrically isolate the faulty subsystem.

The controller 500 is optionally connected to one or more other sensors for detecting other conditions of the mooring buoy 100 and/or the vessel 400. In this way, a plurality of sensors can be connected to the controller 500 to provide multiple different condition parameters of the mooring buoy 100 and/or the vessel 400. This means the controller 500 can energise/and deenergise the output electric cable 204 in a plurality of different scenarios. A discussion of the different sensors that are optionally connected to the controller 500 is discussed below with respect to FIG. 8.

In some examples, the controller 500 is optionally configured to receive condition signals from one or more subsystems in the mooring buoy 100. The condition signal may be an error signal from one or more subsystems of the mooring buoy 100. On receipt of an error signal from a subsystem, the controller 500 issues a deenergise control signal to the mooring buoy main switchboard 506 to trip the output electric cable switchgear 710.

The controller 500 may optionally receive error or fault signals from one or more of e.g. a mooring line monitoring system 532, an HVAC system 510, a corrosion protection system 512, a light system, 514 a bilge pump 516, a fire protection system 518, a navigational warning system 520 or any other subsystem. Whilst FIG. 5 shows the separate subsystems separate from the controller 500, in some other examples, the functions performed by the subsystems are carried out by controller 500.

Optionally, the mooring buoy 100 comprises a mooring line monitoring system 532. The mooring line monitoring system 532 is configured to determine the tension in the mooring line 126. The mooring line monitoring system 532 is connected to a mooring line tension sensor 804 (best shown in FIG. 8). The mooring line tension sensor 804 in some examples is similar to the cable tension sensor 806 as previously discussed.

The controller 500 receives the tension signal from the mooring line tension sensor 804 and determines whether the tension of the mooring line 126 is within a predetermined tension range. In some examples, the controller 500 can issue a control signal to the main mooring buoy switchboard 506 to deenergise the output electric cable 204 when tension in the mooring line 126 exceeds a predetermined tension range. In other words, if the controller 500 determines that the tension in the mooring line 126 exceeds the safe limits of the mooring line 126, then the output electric cable 204 is deenergised before catastrophic failure of the mooring line 126 and potentially the output electric cable 204.

In some examples, the controller 500 compares the signals received from the mooring line tension sensor 804 and the cable tension sensor 806. Accordingly, the controller 500 can determine the relative tensions in the mooring line 126 and the output electrical cable 204.

In some examples, the controller 500 may optionally determine that the tension the mooring line 126 and the output electric cable 204 are below a predetermined threshold tension. For example, the controller 500 determines that the output electric cable tension T_{c} is below the optimal output electric cable tension T_{oc}. Similarly, the controller 500 determines that a mooring line tension Tₘ is below the optimal mooring line tension Tom. In this case, the controller 500 determines that the tension in both the mooring line 126 and the output electric cable 204 indicate that the mooring line 126 and the output electric cable 204 are slack. This may indicate that the vessel 400 is moving towards the mooring buoy 100 if the mooring line tension Tₘ and the output electric cable tension T_{c} continue to reduce or fall to zero. Accordingly, the controller 500 can issue a control signal to the mooring buoy main switchboard 506 to deenergise the output electric cable 204 when tension in the mooring line 126 and/or the output electric cable 204 falls below a predetermined tension.

The mooring buoy 100 optionally comprises a navigation warning system 520. The navigation warning system 520 is connected to a GPS sensor 810 and determines whether the mooring buoy 100 deviates from a predetermined mooring location. In this way, the controller 500 can determine whether the mooring buoy 100 is no longer anchored to the sea floor 200. The controller 500 may determine from location signals of the mooring buoy 100 and/or the vessel 400 that the vessel 400 is moving towards the mooring buoy 100. The navigational warning system 520 may determine the relative positions of the mooring buoy 100 and the vessel 400 and determine whether there is relative change in the distance between the mooring buoy 100 and the vessel 400. Accordingly, the controller 500 can deenergise the mooring buoy 100 before e.g. the vessel 400 collides with the mooring buoy 100 or the input subsea electric cable 118 is damaged.

The controller 500 can optionally be connected or a LIDAR sensor 802 and/or a camera sensor 808 to receive one or more signals of the relative distance of the vessel 400 with respect to the mooring buoy 100. Additionally, other distance sensors can be connected to the controller 500 such as RADAR, laser distance measurement sensor for determining the distance between the vessel 400 and the mooring buoy 100. Similarly, the controller 500 may determine from location signals of the mooring buoy 100 that the vessel 400 is moving towards the mooring buoy 100. Accordingly, the controller 500 can deenergise the mooring buoy 100 before the vessel 400 collides with the mooring buoy 100 if the controller 500 determines from the received signal from the e.g. the LIDAR sensor 802, or the camera sensor 808 from the distance and direction of the vessel 400 that the vessel 400 will collide with the mooring buoy 100.

In some examples the mooring buoy 100 optionally comprises an accelerometer 800 connected to the controller 500. The controller 500 may filter the motion signals received from the accelerometer 800 to remove the movement of the mooring buoy 100 due to the water. Accordingly, the controller 500 can detect a signal from the accelerometer 800 corresponding to an impact e.g. from a collision with the vessel 400. If the controller 500 detects an impact, then the controller 500 can issue a control signal to the mooring buoy main switchboard 506 to deenergise the output electric cable 204.

Optionally, the mooring buoy 100 comprises a corrosion protection system 512. The corrosion protection system 512 is connected to a moisture sensor and determines whether there is water ingress into the internal compartments of the floating body 102. Accordingly, the controller 500 can issue a control signal to the mooring buoy main switchboard 506 to deenergise the output electric cable 204 when salt water is corroding the internal components of the mooring buoy 100.

The fire protection system 518 is connected to a smoke detector and/or a heat sensor and determine whether there is a fire within the mooring buoy 100. Accordingly, the controller 500 can issue a control signal to the mooring buoy main switchboard 506 deenergise the output electric cable 204 when a fire or smoke is detected on the mooring buoy 100.

In some examples, the controller 500 may receive a signal from a connector sensor 828 indicating that the connector 212 of the output electric cable 204 has been physically removed from a socket on the vessel 400. Having received an indication that the connector 212 has been removed from a socket in the vessel 400, the controller 500 can issue a control signal to the mooring buoy main switchboard 506 deenergise the output electric cable 204.

As shown in FIG. 8, the controller 500 can be further connected to one or more other sensors for determining a condition of the vessel 400 and/or the mooring buoy 100. FIG. 8 shows a schematic view of the sensor arrangement in the mooring buoy 100. The controller 500 can be connected to and receive signals from one or more of a LIDAR sensor 802, a camera sensor 808, a mooring line tension sensor 804, a cable tension sensor 806, a voltage sensor 814, a frequency sensor 816, a moisture ingress sensor 826, a connector sensor 828, an accelerometer 800, a GPS sensor 810, a wind speed sensor 818, a water current sensor 822, a humidity sensor 824, a wave height sensor 820, or a smoke/heat detection sensor 812.

Optionally, the controller 500 receives condition signals from e.g. the wind speed sensor 818, the water current sensor 822, the humidity sensor 824, the wave height sensor 820, of the mooring buoy 100 in respect of the weather and sea conditions. In addition, the controller 500 can receive weather and/or sea conditions from via the transmitter receiver of the communication module 616 from a remote data source. Accordingly, the controller 500 can issue a control signal to the mooring buoy main switchboard 506 deenergise the output electric cable 204 when e.g. the wind speed or the weight height is too high and is dangerous for the vessel 400 to be near the mooring buoy 100.

Optionally, the controller 500 receives a manual stop signal from the vessel 400. The manual stop signal is generated from a master stop switch mounted on the bridge of the vessel 400. Accordingly, the controller 500 can issue a control signal to the mooring buoy main switchboard 506 deenergise the output electric cable 204 when the manual stop signal is received. Accordingly, the crew on the vessel 400 can manually interrupt the power supply from the output electric cable 204 in an emergency. The manual stop signal may be transmitted over the at least one data connection 612, 614 between the vessel 400 and the mooring buoy 100.

The controller 500 may be a data processing device that may be implemented by special-purpose software (or firmware) run on one or more general-purpose or special-purpose computing devices, such as hardware processor(s). Each “element” or “means” of such a computing device refers to a conceptual equivalent of a method step; there is not always a one-to-one correspondence between elements/means and particular pieces of hardware or software routines. One piece of hardware sometimes comprises different means/elements. For example, a processing unit serves as one element/means when executing one instruction but serves as another element/means when executing another instruction. In addition, one element/means may be implemented by one instruction in some cases, but by a plurality of instructions in some other cases. Such a software-controlled computing device may include one or more processing units, e.g. a CPU (“Central Processing Unit”), a DSP (“Digital Signal Processor”), an ASIC (“Application-Specific Integrated Circuit”), discrete analogue and/or digital components, or some other programmable logical device, such as an FPGA (“Field Programmable Gate Array”). The data processing device may further include a system memory and a system bus that couples various system components including the system memory to the processing unit. The system bus may be any of several types of bus structures including a memory bus or memory controller, a peripheral bus, and a local bus using any of a variety of bus architectures. The system memory may include computer storage media in the form of volatile and/or non-volatile memory such as read only memory (ROM), random access memory (RAM) and flash memory. The special-purpose software may be stored in the system memory, or on other removable/non-removable volatile/non-volatile computer storage media which is included in or accessible to the computing device, such as magnetic media, optical media, flash memory cards, digital tape, solid state RAM, solid state ROM, etc. The special-purpose software may be provided to the data processing device on any suitable computer-readable medium, including a record medium and a read-only memory.

The electrical connections between the mooring buoy 100 and the vessel 400 will now be discussed in reference to FIGS. 6 and 7. FIG. 6 shows a system diagram of the mooring buoy 100 connected to a power generator. FIG. 7 shows a schematic circuit diagram of the mooring buoy 100.

As mentioned above, the mooring buoy 100 is connected to the external power supply by the input subsea electric cable 118. As shown in FIG. 6, the input subsea electrical cable 118 is electrically connected to a wind turbine generator (WTG) 600. The WTG 600 comprises a WTG transformer 602 coupled to a WTG high voltage switchboard 604. The WTG high voltage switchboard is connected to WTG switchgear 606 for selectively energising the input subsea electric cable 118. This means that the mooring buoy 100 can be isolated from the WTG 600 by controlling the WTG high voltage switchboard 604.

Additionally, or alternatively, the input subsea electric cable 118 is optionally connected to a shore generator 608. The optionally direct shore electrical connection of the input subsea electric cable 118 is shown by the dotted line between the shore generator 608 and the input subsea electric cable 118. The shore generator 608 schematically represents any land based electrical generator or electrical distribution network. In some examples, the shore generator 608 is an electrical substation comprising shore switchgear 610 for selectively energising the input subsea electric cable 118.

Whilst FIG. 6 shows that the mooring buoy 100 is electrically connected to the WTG 600, in other examples, other offshore power generators can be used. For example, the input subsea electric cable 118 can be connected to an offshore installation comprising power generation or power storage such as a wave generator etc.

The output electrical cable 204 is connected between the vessel 400 and the mooring buoy 100. In addition to the electrical connection, in some examples there is at least one data connection 612 between the mooring buoy 100 and the vessel 400. Similarly, in some examples there is at least one data connection 612, 614 between the mooring buoy 100 and the WTG 600.

In some examples, the output electrical cable 204 and the input subsea electric cable 118 also comprise one or more wired data connections 612. Accordingly the at least one data connection 612 is an optical fibre between the mooring buoy 100 and the vessel 400. In this way, the output electrical cable 204 and the input subsea electric cable 118 comprises an integrated data cable such as an optical fibre cable.

In some examples, the first rotatable electrical connection 226 and the second rotatable electrical connection 310 as discussed in reference to FIG. 2, are also rotatable data connections. In this way, both power and data for example telemetry data relating to the operation of the mooring buoy 100 can be transmitted from the stationary portion 122 to the rotatable portion 120.

In some examples, the at least one data connection between the mooring buoy 100 and the vessel 400 comprises a wireless data connection 614. Each of the mooring buoy 100 and the vessel 400 each comprises a communication module 616, 618 comprising transmitter-receiver for transmitting data therebetween. The wireless data connection can optionally be a licensed wireless data connection or an unlicensed wireless data connection. In some examples, the wireless data connection can use any of the following protocols: Low Power Wide Area Network (LPWAN), Long Term Evolution (LTE), GSM, 5G, LoRa, WIFI, Bluetooth, ZigBee or any other suitable wireless communication protocol.

The wireless data connection 614 can be used in addition to or alternatively to the wired data connection 612. In some examples, the wireless data connection 614 is used by the vessel 400 to communicate with the mooring buoy 100 before the vessel 400 has connected the output electrical cable 204. In some examples, the wireless data connection 614 transmits data between the vessel 400 and the mooring buoy 100 until the output electrical cable 204 is energised.

The at least one data connection 612 between the vessel 400 and the mooring buoy 100 is used to transmit vessel parameter data to a mooring buoy controller 500. For example the vessel parameter data can be transmitted between the wireless data connection 614 or the wired data connection 612. Accordingly the mooring buoy controller 500 can determine the status of the vessel 400 whilst the output electrical cable 204 is energised. Examples of the vessel status parameters can be one of more of vessel status, power demand of the vessel, vessel location, fault status of the vessel, vessel switchboard 624 fault status, vessel circuit breaker 622 status, vessel engine status, output electric cable 204 status, and/or any other information of the vessel 400.

Additionally or alternatively, the at least one data connection 612 can be used to provide an internet connection for the vessel 400. Advantageously, this means that the vessel 400 can have a faster data connection because the vessel 400 is not relying on slower data connections such as satellite communications.

The controller 500 can receive status updates e.g. “OK” messages from the vessel 400 whilst the output electrical cable 204 is energised. This means that the controller 500 can determine whether there are any fault conditions during operation e.g. an electrical fault with the vessel switchboard 624 or a connectivity fault with the data connection 612. The controller 500 can determine that the wired data connection 612 and/or the wireless data connection 614 have been lost and no data is being transmitted between the vessel 400 and the mooring buoy 100. If the controller 500 determines after a predetermined period of time that no data packet e.g. OK message has not been received, controller 500 determines that the data connections 612, 614 have failed. Accordingly, the controller 500 can issue a control signal to the mooring buoy main switchboard 506 deenergise the output electric cable 204 when communication is lost between the mooring buoy 100 and the vessel 400.

Further examples of data communication between the vessel 400 and the mooring buoy 100 will be discussed in more detail below.

Turning to FIG. 7 the electrical connection between the mooring buoy 100 and the vessel 400 will be discussed in more detail.

The input subsea electric cable 118 is connected to a first mooring buoy circuit breaker 508. The first mooring buoy circuit breaker 508 is arranged to electrically isolate the mooring buoy 100 from the input subsea electric cable 118 if an electrical fault is detected in the input subsea electric cable 118 or e.g. the WTG 600. The input subsea electric cable 118 comprises an electrical supply at 34 kV and 50 Hz. However, in other examples the input subsea electric cable 118 can comprise a different voltage and frequency if required. The first mooring buoy circuit breaker 508 may be rated at 750 kVA. The first mooring buoy circuit breaker 508 is connected to a first step-down transformer 704 to step the input voltage down from 34 kV to 690 VAC.

In some examples, the first step-down transformer 704 is mounted in the stationary portion 122. This means the heavy first step-down transformer 704 is positioned towards the bottom of the mooring buoy 100 and improves the stability of the mooring buoy 100. The output of the first step-down transformer 704 is electrically connected to the input of the first rotatable electrical connection 226. In some examples, the first step-down transformer 704 is configured to supply the voltage at 440V, 690V and/or any other voltage as required by the vessel 400. In some examples the first step-down transformer 704 is configured to step down the voltage from a high voltage e.g. 34 kV, 11 kV or 7 kV to 440V and/or 690V. The first step-down transformer 704 can have a plurality of taps for providing different voltages as required e.g. 440V or 690V. The controller 500 can issue a voltage control instruction to selectively modify the output voltage from the first step-down transformer 704. The controller 500 may issue the voltage control instruction in dependence of receiving information from the vessel 400 over the wireless data connection 614. Accordingly, the controller 500 can initialise the mooring buoy 100 and the mooring buoy main switchboard 506 before the vessel 400 is connected to the output electrical cable 204.

A frequency converter 706 is connected to the first step-down transformer 704. The frequency converter 706 converts the voltage from a 50 Hz to 60 Hz power supply as required. The frequency of the electrical power supply provided in the output electrical cable 204 will depend on the requirements of the vessel 400.

The first rotatable electrical connection 226 is also optionally connected to a stationary junction box 312 (as best shown in FIG. 3). The stationary junction box 312 is mounted in the stationary portion 122. The stationary junction box 312 is a sealed enclosure for housing connections between an input from the rotatable electrical connection 226 and the input subsea electric cable 118. In some examples, the connections between the input from the first rotatable electrical connection 226 and the input subsea electric cable 118 are pigtail connections.

Alternatively the input subsea electric cable 118 provides the voltage at the same voltage provided by the output electrical cable 204 e.g. 440V or 690V. For example, an external step down transformer (not shown) can be provided adjacent to the mooring buoy 100 or an onshore step down transformer (not shown) is provided at a closest position to the mooring buoy 100 on land. In this case, the mooring buoy 100 comprises no transformers mounted in the rotatable portion 120 or the stationary portion 122.

The output form the frequency converter 706 is connected to a second mooring buoy circuit breaker 708. The second mooring buoy circuit breaker 708 is optionally connected to the output electric cable switchgear 710. The second mooring buoy circuit breaker 708 and/or the output electric cable switchgear 710 are configured to trip in order to isolate the vessel 400 from the mooring buoy 100 if an electrical fault is detected. The second mooring buoy circuit breaker 708 and/or the output electric cable switchgear 710 are connected to the second rotatable electrical connection 310. As mentioned above, the output electric cable 204 is rotatably and electrically connected to the second rotatable electrical connection 310.

The mooring buoy 100 comprises a mooring buoy main switchboard 506 for providing power to one or more internal components and subsystems of the mooring buoy 100. The mooring buoy main switchboard 506 is connected to a first low voltage switchboard 718 via a second step-down transformer 714. The second step-down transformer 714 steps the voltage down from 690 VAC to 440 VAC. A third step-down transformer 716 is connected between the first low voltage switchboard 718 and a second low voltage switchboard 722. The third step-down transformer 716 steps the voltage down from 440 VAC to 230 VAC. A DC switchboard 726 is connected to the second low voltage switchboard 722 via a fourth step-down transformer 720 and an AC-DC converter 724. The fourth step-down transformer 720 steps the voltage down to 24 VAC and the AC-DC converter 724 converts the AC voltage to DC voltage e.g. converting the voltage down from 230 VAC to 24 VDC.

As shown in FIG. 7, the cable length adjustment mechanism 230 is connected to the mooring buoy main switchboard 506. The HVAC system 510 is connected to the first low voltage switchboard 718. The corrosion protection system 512, the light system 514, the bilge pump 516, and the mooring line monitoring system 532 are connected to the second low voltage switchboard 722. The CCTV system 700, the navigational warning system 520, the fire protection system 518, the alarm and monitoring system 504, the emergency light system and the communication module 616 are connected to the DC switchboard 726. In case the DC switchboard 726 loses power from the mooring buoy main switchboard 506, a battery 540 is connected to the DC switchboard 726 to provide power. This means that some essential functions of the mooring buoy 100 can continue to operate.

Another example will now be described. As mentioned previously, the mooring buoy 100 comprises at least one data connection 612, 614 between the mooring buoy 100 and the vessel 400.

The at least one data connection 612, 614 is connectable to a local network (not shown) of the vessel 400. In some examples, the local network of the vessel 400 is a local area network and one or more local computers and/or vessel systems are connected to the local area network. As mentioned above, the at least one data connection 612, 614 can provide a broadband data connection and therefore the at least one data connection 612, 614 provides broadband data connection to the local area network of the vessel 400.

The controller 500 is configured to receive vessel parameter data from the vessel 400 over the at least one data connection 612, 614. In some examples, controller 500 is arranged to selectively control the energisation of the output electric cable 204 in response to the received vessel parameter data. For example, the controller 500 may only energise the output electric cable 204 once the vessel 400 has provided a suitable unique vessel ID. In addition, or alternatively, the controller 500 may only energise the output electric cable 204 once the controller 500 has performed a handshake and exchanged authentication information with the vessel 400.

The controller 500 may receive vessel parameter data from the vessel 400. The controller 500 may adapt the energisation of the output electric cable 204 in dependence of the received vessel parameter data. For example, the controller 500 may issue control signals to modify the voltage (440 VAC or 690 VAC) and/or the frequency (50 Hz or 60 Hz) in dependence of the received vessel parameter data.

In some examples, the received vessel parameter data may be power requirements of the vessel 400 such as voltage, current, frequency required on the output electric cable 204. The controller 500 will issue control signal to modify the energisation of the output electric cable 204 accordingly.

In some examples, the controller 500 may optionally receive a unique vessel ID and look up power requirements of the vessel 400 in a look up table stored in memory based on the unique vessel ID. The controller 500 can then similarly modify the energisation of the output electric cable 204 accordingly.

The controller 500 may only issue a control signal to energise the output electric cable 204 once the vessel 400 has performed safety checks and sends an “OK to energise” signal over the at least one data connection 612, 614.

Once the controller 500 determines that the vessel 400 is ready, the controller 500 may issue a control signal to energise the output electric cable 204. When the output electric cable 204 is energised, the controller 500 optionally logs energy consumption of the vessel 400 and/or data consumption of the vessel 400 with the unique vessel ID in the memory.

In some examples the controller 500 receives data in respect of energy consumption of the vessel 400 and/or data consumption of the vessel 400 from the internal subsystems of the mooring buoy 100. In some alternative examples, the controller 500 is configured to receive energy consumption data of the vessel 400 and/or data consumption data of the vessel 400 over the at least one data connection 612, 614. The controller 500 then stores the energy consumption data of the vessel 400 and/or data consumption data of the vessel 400 with the unique vessel ID in the memory. In this way the controller 500 can monitor the energy and data usage of the vessel 400 and determine whether the maintenance needs to be performed on the vessel 400.

In another example, two or more examples are combined. Features of one example can be combined with features of other examples.

Examples of the present disclosure have been discussed with particular reference to the examples illustrated. However it will be appreciated that variations and modifications may be made to the examples described within the scope of the disclosure.

1. A mooring installation for a vessel, the mooring installation comprising:
a body;
at least one mooring line arranged to be coupled between the mooring installation and the vessel;
at least one electric cable connected to an external power supply, the at least one electric cable being arranged to electrically connect to an electric circuit of the vessel;
at least one mooring installation circuit switch electrically connected to the at least one electric cable and configured to deenergise power to the at least one electric cable;
a controller having a processor and arranged to selectively control the at least one mooring installation circuit switch; and
at least one sensor arranged to detect a condition of at least one of the mooring installation or the vessel, and send a condition signal to the controller;
wherein the controller is configured to actuate the mooring installation circuit switch in response to a received condition signal from the at least one sensor and deenergise the at least one electric cable.

2. The mooring installation according to claim 1, wherein the mooring installation circuit switch is a mooring installation circuit breaker or switchgear.

3. The mooring installation according to claim 1, wherein the at least one sensor is a tension sensor arranged to detect tension in the at least one electric cable.

4. The mooring installation according to claim 3, wherein the controller is arranged to actuate the mooring installation circuit switch when the detected tension in the at least one electric cable exceeds a threshold.

5. The mooring installation according to claim 1, wherein the at least one sensor is a tension sensor arranged to detect tension in the at least one mooring line.

6. The mooring installation according to claim 5, wherein the controller is arranged to actuate the mooring installation be circuit switch when the detected tension in the at least one mooring line is outside a threshold tension range.

7. The mooring installation according to claim 1, wherein at least one vessel circuit breaker is electrically connected between the electric circuit of the vessel and the at least one electric cable, and the controller is configured to actuate the at least one vessel circuit breaker in response to the condition signal from the at least one sensor.

8. The mooring installation according to claim 1, wherein at least one data connection is arranged to transmit vessel parameter data between the mooring installation and the vessel.

9. The mooring installation according to claim 8, wherein the at least one data connection comprises a broadband internet connection between the mooring installation and the vessel.

10. The mooring installation according to claim 8, wherein the at least one data connection comprises an optical fibre in the at least one electric cable.

11. The mooring installation according to claim 8, wherein the at least one data connection comprises a wireless data connection between the mooring installation and the vessel.

12. The mooring installation according to claim 8, wherein the controller is configured to actuate the at least one mooring installation circuit switch in respect to a loss in connectivity in the at least one data connection between the vessel and the mooring installation.

13. The mooring installation according to claim 1, wherein the at least one sensor includes one or more of a LIDAR, a camera, a voltage sensor, a frequency sensor, a moisture sensor, an accelerometer, GPS sensor, wind speed sensor, current sensor, humidity sensor, wave height sensor, or smoke detection sensor.

14. The mooring installation according to claim 1, wherein the external power supply is an offshore power generator and at least one power generator circuit switch is electrically connected between the offshore power generator and the at least one mooring installation circuit switch.

15. A mooring installation for a vessel, the mooring installation comprising:
a body;
at least one mooring line arranged to be coupled between the mooring installation and the vessel;
at least one electric cable connected to an external power supply, the at least one electric cable being arranged to electrically connect to an electric circuit of the vessel;
at least one data connection arranged to connect to a local network of the vessel;
at least one mooring installation circuit switch electrically connected to the at least one electric cable, and configured to modify an energisation of the at least one electric cable;
a controller having a processor and arranged to receive vessel parameter data from the vessel over the at least one data connection;
wherein the controller is arranged to selectively control the at least one mooring installation circuit switch in response to the received vessel parameter data.

16. The mooring installation according to claim 15, wherein the vessel parameter data comprises a unique vessel ID.

17. The mooring installation according to claim 16, wherein the controller is configured to modify power supplied to the mooring installation in dependence on stored vessel information and the unique vessel ID.

18. The mooring installation according to claim 15, wherein the controller is configured to receive at least one of energy consumption data of the vessel or data consumption data of the vessel over the at least one data connection.

19. The mooring installation according to claim 16, wherein the controller comprises a memory and is configured to store at least one of energy consumption of the vessel or data consumption of the vessel with the unique vessel ID in the memory.

20. The mooring installation according to claim 15, wherein the at least one data connection comprises a broadband internet connection between the mooring installation and the local network of the vessel.

21. The mooring installation according to claim 15, wherein the at least one data connection comprises an optical fibre in the at least one electric cable.

22. The mooring installation of claim 1, wherein
the mooring installation is a mooring buoy,
the body is a floating body, and
the mooring buoy includes at least one anchoring line connected between the floating body and the sea floor.

23. The mooring installation of claim 15, wherein
the mooring installation is a mooring buoy,
the body is a floating body, and
the mooring buoy includes at least one anchoring line connected between the floating body and the sea floor.
